(19) United States
(12) Patent Application Publication
(10) Pub. No.: US 2026/0148077 A1
(43) Pub. Date: May 28, 2026

(54) SUPERVISED AND UNSUPERVISED LEARNING METHOD BY FAST CONVERGING NETWORK IN AN AI CHIP USING PROCESSING ELEMENTS

(71) Applicant: RASIQ S M, Kottayam (IN)

(72) Inventor: RASIQ S M, KOTTAYAM (IN)

(73) Assignee: RASIQ S M, Kottayam, KL (IN)

(21) Appl. No.: 19/480,041

(22) PCT Filed: May 5, 2024
(86) PCT No.: PCT/IN2024/050483

§ 371 Date: Oct. 30, 2025

(30) Foreign Application Priority Data
May 6, 2023 (IN) 202341032196

(51) Int. Cl. G06N 3/0895; G06N 3/065

(52) U.S. Cl. CPC G06N 3/0895; G06N 3/065

(57) ABSTRACT

An AI chip device with a fast-converging network that manipulates a large number of variables and finds inter variable relations and hidden patterns, which it learns and converges rapidly. It utilizes a self-learning device (SALS Device) for finding the divergence to provide a parameter for feedback, and converges rapidly. It employs methods such as the “SALS Model” and the “AIW Method” (approximation by iteration of weight) to converge the network fast and to determine the relation between two variables to combine the feature variables into an output variable using a weight and the combined variables are combined again and again until a single output is obtained. It is capable of supervised and unsupervised learning by using its property of convergence.

### CROSS-REFERENCE TO RELATED APPLICATIONS

The present application is a continuation of an International Application No. PCT/IN2024/050483 with a filing date of 5 May 2024, the entire disclosure of which is incorporated herein by reference for all purposes. The present application claims the benefit of Indian priority application No. 202341032196 with a filing date of 6 May 2023, the entire disclosure of which is incorporated herein by reference for all purposes.

### FIELD OF THE INVENTION

The present invention relates to the field of Artificial Intelligence and Machine Learning, and more particularly to the neural network that aids in fast convergence with optimum computation and minimum number of learning samples. The present invention introduces a device that supports supervised and unsupervised learning.

### BACKGROUND OF THE INVENTION

Artificial Intelligence has become an increasingly important part of human life in recent years. Artificial neural networks are widely used in AI applications such as supervised learning and unsupervised learning. It is found that artificial neural networks have some drawbacks such as a neuron manipulating a large number of variables at a time, it is not predictable what is happening inside the neural network layers, for different applications different structures of neural networks are needed and they have many hyper parameters that need to be tuned, such as learning rate, batch size, number of layers, and number of neurons per layer. Finding the optimal hyper parameters can be a difficult and time-consuming task, and its convergence has some limitations. “Convergence” refers to the process where the parameters (like weights and biases) of a neural network adjust themselves during training to reach an optimal state. This optimal state typically means that the network's predictions or outputs closely match the desired targets.

To address the challenges inherent in the current scenario, the present invention introduces “Supervised and Unsupervised Learning by Fast Converging Network using Processing Elements”. The present invention features the SALS model which provides a parameter for convergence that processes a single variable at a time and the weight value converges when the SALS model converges. The present invention provides a solution for solving data classification, data clustering, and finding relations among variables. In order to optimize the computational complexity, the number of weights inside the network has been optimized. A weight inside the network is found by a method named approximation by iteration of the weight method. This method finds weights among nodes using an exponential learning rate. The present system is capable of performing various types of learning tasks, including supervised learning (where the model learns from labeled data) and unsupervised learning (where the model identifies patterns in unlabeled data).

Various Prior Arts have Disclosed Similar Systems and Methods

WIPO Patent Application WO2021075735A1 discloses the method of training a Neural Network using Periodic sampling over model weights. This prior art involves initializing model parameters, performing forward and backward passes on training data, and updating node weights based on gradient descent. it calculates new mean weight values for nodes and updates weights accordingly. Finally, after training on a set number of mini batches, it assigns running means as weights and resets them for further training. It is important to highlight that the present invention uses methods such as the “SALS Model” and the “AIW Method” (approximation by iteration of weight) to converge the network fast and to determine the relation between two variables to combine the feature variables into a single output. In addition to that, the present invention is capable of supervised and unsupervised learning by using its property of convergence.

Chinese Patent Application CN117333691 discloses the method of optimizing parallel artificial intelligence processing using a derivative neural network. In this prior art, inference, and training logic stores forward and output weights, input/output data, and neuron or layer parameters in code and/or data storage. Training logic may also include graphics code to control timing and sequence, loading weights and parameters into arithmetic logic units based on the neural network architecture. Data storage holds input/output data and weight parameters for each layer during training and inference. The present invention consists of an array of layers such as DFF, LDFB, and RTMC constructed by processing elements. Each processing element performs the AIW Method and SALS model.

U.S. Pat. No. 11,074,495B discloses the system and method for an extremely efficient image and pattern recognition and artificial intelligence platform, where the weights between hidden units within the same layer are eliminated to simplify the learning process. The learning process tends to modify the weights and biases so that the energy state associated with the samples learned is lowered and the probability of such states is increased. It is pertinent to note that the present invention utilizes AIW Method (approximation by iteration of weight) to converge the network fast and to determine the relation between two variables to combine the feature variables into a single output. The present invention's network achieves convergence after a single epoch, achieving 98.66% accuracy in data classification and it demonstrated relatively low computational complexity during convergence.

Considering the aforementioned prior arts, the present invention distinguishes itself in several key aspects. The present invention's network could be converged by a single epoch for classification. With a few numbers of training samples, the network learns to predict the class with 94.96% accuracy. The computational complexity is comparatively less for the convergence of the network. Also, the network computes relations among input variables when weights converge. In addition, the network supports supervised and unsupervised learning by including only relevant relations among the input variables. The network structure is almost fixed and there are no complicated activation functions inside the network. The number of processing elements in each layer is limited by limiting the valid outputs of the previous layer. This network is a significant step for a general-purpose AI chip, including supervised and unsupervised learning. Also, it can process images for classification and short videos for encoding. The training is performed with different numbers of sample variables ranging from 2 to 719 and testing accuracies are evaluated for a particular data set (with Pen-Based Recognition of Handwritten Digits data set). The testing accuracy for two training samples is 94.96% and for entire samples is 98.66%. The present system supports both supervised and unsupervised learning by emphasizing relations among the variables and facilitating tasks such as image classification and short video encoding.

### OBJECTS OF THE INVENTION

It is the main object of the present invention to provide a fast-converging network by individually processing each weight and enhancing the variables through pairwise combinations.

It is the primary objective of this invention to provide a self-learning device that manipulates a single variable at a time, it learns and converges rapidly.

It is another object of the present invention to provide a device with a fast-converging network that leads to finding an optimum value of weight using approximation by iteration of the weight method.

It is another object of the present invention to provide the device with a fast-converging network in which the relation among the input variables can be determined by considering interactions between pairs of variables.

It is another object of the present invention to provide a network that achieves convergence after a single epoch, especially effective with a small training data set, achieving a 94.96% accuracy in data classification.

It is another object of the present invention to provide an AI chip with a fast-converging network that features an array processor consisting of a large number of processing elements (PE).

It is another object of the present invention to provide the network for classification function consisting of three kinds of layers: Divergence for the Feature Filtering layer, Least Divergence Feature in a Block layer, and Reverse Tree Method of Combination layer.

It is another object of the present invention to provide the network with relatively low computational complexity during convergence.

It is another object of the present invention to provide a network that supports both supervised and unsupervised learning by emphasizing relevant relations among input variables, facilitating tasks such as image classification and short video encoding.

It is another object of the present invention to provide a network in which each step of processing is recorded and transferred as trained data into a memory unit. This memory unit provides data to identify classes and patterns of the input data.

### SUMMARY OF THE INVENTION

The present invention is a self-learning device (SALS Device) that manipulates a single variable at a time, it learns and converges rapidly, and it is named a SALS device. The present invention uses methods such as the “SALS Model” and the “AIW Method” (approximation by iteration of weight) to converge the network fast and to determine the relation between two variables to combine the feature variables into a single output. The present invention is capable of supervised and unsupervised learning by using its property of convergence.

The present system features a network with different layers consisting of a large number of processing elements (“PE”) in each layer. Each PE can combine two variables into a single variable by multiplying one of the variables with a weight. The output of a PE is connected to the SALS device.

The present system is capable of employing the classification function for various data types, such as videos, images, text, and voice, by utilizing their labels. The data types are converted into variables and applied as input to the network.

The network for classification function consists of three kinds of layers Divergence for the Feature Filtering layer (DFF), Least Divergence Feature in a Block layer (LDFB), and Reverse Tree Method of Combination layer (RTMC). These are for determining the relations among variables, limiting the number of valid outputs, and combining output variables in the previous layer respectively.

### BRIEF DESCRIPTION OF THE DRAWINGS

FIG. 1 shows the circuit diagram of a SALS device using digital components such as comparators, memories, logical AND and OR gates, subtractors, and a divider.

FIG. 2 shows a pictorial representation of Divergence for Feature Filtering layers. The first layer is the input layer, and the remaining layers perform the Divergence for Feature Filtering method.

FIG. 3 shows a graph in which the horizontal axis shows the threshold value, the left vertical axis shows the valid number of AIW outputs using the TVA in a DFF method and the right vertical axis shows the valid number of AIW outputs using the TVM in a DFF method.

FIG. 4 shows a graph in which the horizontal axis represents the threshold values, the left vertical axis represents the number of valid outputs of the AIW model using the TVA in an LDFB method, and the right vertical axis shows the number of valid outputs of AIW method using TVM in an LDFB method.

FIG. 5 illustrates the model classification network in which input is applied in layer 1, layers 2 to 4 extract inter-variable relations, layer 5 limits the number of outputs, and layer 6 combines the outputs of layer 5 to a single output O.

FIG. 6 shows a graph in which the horizontal axis shows a number of training samples, the left vertical axis shows the number of valid outputs at layer 2 using the DFF method, and the right vertical axis shows the threshold values applied for each number of training samples.

FIG. 7 shows a graph in which the horizontal axis shows the number of training samples, the left vertical axis shows the number of valid outputs at layer 3 using the DFF method, and the right vertical axis shows the threshold values applied for each number of training samples.

FIG. 8 shows a graph in which the horizontal axis shows the number of training samples, the left vertical axis shows the number of valid outputs at layer 4 using the DFF method, and the vertical right axis shows the threshold values applied for each number of training samples.

FIG. 9 shows a graph in which the horizontal axis shows the number of training samples, vertical axis shows the average prediction accuracy of the Pen-Based Recognition of Handwritten Digits data set.

FIG. 10 shows image clustering, random images of three objects from the Washington RGB object data set are selected, and each image is initially labeled from 0 to N−1.

While the invention is amenable to various modifications and alternative forms, specifics thereof have been shown by way of examples in the drawings and will be described in detail. It should be understood, however, that the intention is not to limit the invention to the particular embodiments described. On the contrary, the intention is to cover all modifications, equivalents, and alternatives falling within the spirit and scope of the invention.

Hereinafter, preferred embodiments of the present invention will be described in detail with reference to the accompanying drawings. Prior to this, terms and words used in the present specification and claims should not be construed as limited to ordinary or dictionary terms. The present invention should be construed as meaning and concept consistent with the technical idea of the present invention based on the principle that it can be defined. Therefore, the embodiments described in this specification and the configurations shown in the drawings are only the most preferred embodiments of the present invention and do not represent all the technical ideas of the present invention. Therefore, it should be understood that equivalents and modifications are possible.

### DETAILED DESCRIPTION OF THE INVENTION WITH RESPECT TO THE DRAWINGS

The present invention as embodied by “Supervised and Unsupervised Learning method by Fast Converging Network in an AI chip using Processing Elements” succinctly fulfils the above-mentioned need(s) in the art. The present invention has objective(s) arising as a result of the above-mentioned need(s), said objective(s) being enumerated below. In as much as the objective(s) of the present invention are enumerated, it will be obvious to a person skilled in the art that, the enumerated objective(s) are not exhaustive of the present invention in its entirety, and are enclosed solely for the purpose of illustration. Further, the present invention encloses within its scope and purview, any structural alternative(s) and/or any functional equivalent(s) even though, such structural alternative(s) and/or any functional equivalent(s) are not mentioned explicitly herein or elsewhere, in the present disclosure. The present invention therefore encompasses also, any improvisation(s)/modification(s) applied to the structural alternative(s)/functional alternative(s) within its scope and purview. The present invention may be embodied in other specific form(s) without departing from the spirit or essential attributes thereof.

Throughout this specification, the use of the word “comprise” and variations such as “comprises” and “comprising” may imply the inclusion of an element or elements not specifically recited.

### Key Definitions

Processing Element (PE): It is a sub processor within the network, which has two parts A and B. Both parts contain n number of N-bit memory locations and each location contains a float value.

Network is a combination of different layers such as Divergence for the Feature Filtering layer (DFF), Least Divergence Feature in a Block layer (LDFB), Reverse Tree Method of Combination layer (RTMC). Each layer consists of a large number of processing elements (“PE”).

Supervised learning from feature space refers to a type of machine learning where the model is trained on a dataset with a supervision or label, wherein the entire number of variables are considered as features and the multidimensional space formed by these features is called feature space. A learning sample is a point in the feature space.

Unsupervised learning from feature space refers to a type of machine learning where the model is trained on a dataset without any supervision or label. Instead, the model is trained to learn patterns and relationships from the input data based on the features or characteristics of the data.

Classification refers to the process of organizing or categorizing data based on its distinct attributes. This process allows the system to categorize the input data accurately, enabling various applications such as image recognition, text analysis, and speech recognition. Wherein attributes denote the samples or points in the feature space.

### Key Abbreviations

PE—Processing Elements
SALS—Self Learning Device
AIW—Approximation by iteration of weight
DFF—Divergence for the Feature Filtering layer
LDFB—Least Divergence Feature in a Block layer
RTMC—Reverse Tree Method of Combination layer
TVA—Two Variable Addition Method
TVM—Two Variable Multiplication method

The present invention uses the “SALS Model” and “AIW Method” (approximation by iteration of weight) to converge the network fast and to determine the relation between two variables to combine the feature variables into a single output. It employs the method of exponential learning rate to facilitate the convergence process. The network achieves convergence after a single epoch, achieving 98.66% accuracy in data classification. It demonstrated relatively low computational complexity during convergence. The present system supports both supervised and unsupervised learning by emphasizing relations among the variables and facilitating tasks such as image classification and short video encoding.

In the present invention, the AI chip consists of a network with three different layers including Divergence for the Feature Filtering layer (DFF), Least Divergence Feature in a Block layer (LDFB), and Reverse Tree Method of Combination layer (RTMC). Each layer performs different functions as described below. Wherein the resultant network is a combination of layers, and each layer comprises of unidirectional PE arrays. The LDFB layers are defined as: wherein for n variables, n(n−1)/2 number of combinations are possible as shown in the equation (12), then n−1, n−2, n−3, . . . , 1 are the different number of combinations for n−1 blocks. This method denotes wherein one relation in each block has the least div value.

DFF: This layer within the network is used to find a number of relations among the variables by combining them as pairs.

LDFB: Another layer within the network is used to find a number of relations among the variables by pairing them together. However, the number of relations is always less than the number of input variables applied.

RTMC: This layer in the network is used to combine the input variables using multiple iterative steps. With each step, the number of variables is reduced to less than half of the input variable. These steps continue until the variable number becomes one.

In the present system, each of the above-mentioned layers comprises multiple processing elements (PE). Each processing element performs the AIW method, which involves combining two variables through addition or multiplication using a weight. The value of the weight is determined by the AIW method, which employs an exponentially decaying learning rate. This approach ensures fast convergence, allowing the system to reach optimal solutions quickly.

Wherein the exponentially decaying learning rate denotes: if the initially assumed weight is w, then the weight change is as follows, itray=w/q⁽ⁱ⁺¹⁾ where itray is the weight change, and q ranges from 1 to 2 and i is the number of iterations. In other words, the weight change in each step is exponentially decaying. The weight change is added or subtracted with the current weight by comparing present and past divergence values and weights.

The self-learning device like a neuron needs a large number of learning samples, and the neuron manipulates several variables as inputs at a time. It produces an output that is high or low depending on the inputs, weights, and threshold value. The models used for learning require complex computations. The learning steps of a neuron include several iterations of additions, subtractions, multiplications, and divisions. When neural networks constructed with a large number of neurons are considered, model complexity is high.

The SALS device manipulates a single variable value, which may be sensor output values or measurements of parameters and these values can be used for supervised and unsupervised learning applications. For supervised learning a label is required for each variable, and the label represents the nature of the variable, whether it is in a particular range or not. If the label is not present, then unsupervised learning without a label is performed. Inside the network, multiple variables are combined into a single variable.

According to the present invention. a sensor may be temperature sensor, humidity sensor, and/or pressure sensor which is used to convert parameters such as temperature, humidity, and pressure into variables.

At the developing stage, the SALS device was a supervised learning device. It required one variable and its label as a set of input and label pairs for learning. These pairs are considered as a single integer variable and their label is in digital form. The label is high (1) for input variable values within a range and low (0) for input variable values outside the range. The SALS device further satisfies the following conditions/steps:

If the input variable is within a range, between a lower limit value and an upper limit value, then its label is high wherein the range of the input variable is between x1 and x2 as given below.

The input variable values are learnable using a simple learning model when the label is high.

The device can produce the label high with the same input variable in the range and the device can produce the label low with the same input variable outside the range after learning.

The tested input-output pairs satisfy the input-label relations in the learning pairs.

$$The value of divergence = \{ ( upper limit - lower limit ) / upper limit \} is measureable , wherein for convergence divergence should be less than a minimum value for a particular data set .$$

The SALS device can produce an output high after learning is completed if the input variable is in a particular range. The SALS device learns to produce an output from training samples of (X, Y) pairs. The variable X has continuous values and Y has digital values. If the variable X is between a particular range, then its label Y is high; otherwise, low. The SALS device learns the range of X using the SALS model and its processing time is very low. Learning is the function of finding the values of lower limit k and upper limit k′ if the training input variable is available. Wherein, before processing a datatype is converted into numeric values.

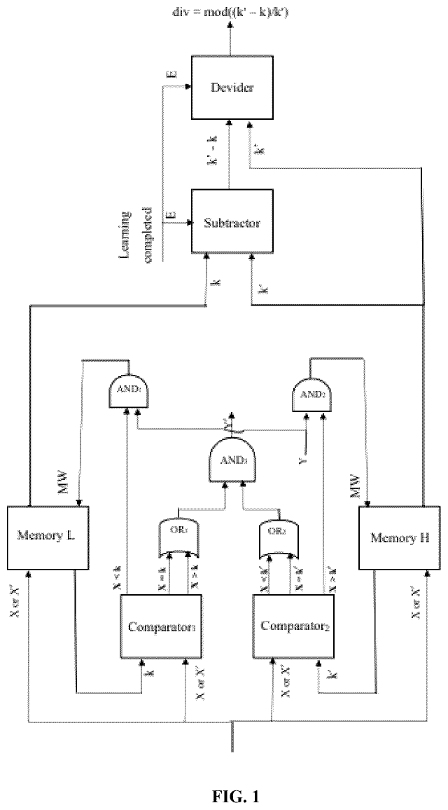

FIG. 1 shows the circuit diagram of a SALS device. The circuit diagram of a SALS device includes two N-bit comparators, two N-bit memory locations, an N-bit subtractor, an N-bit divider, three AND gates, and two OR gates. At the learning stage, comparators compare the input variable X with the contents of memory locations H and L represented as k′ and k respectively. If the value of X is less than k, then the output of comparator1, X<k becomes high and if Y input is high then the corresponding AND1 gate output produces MW (“memory write”) high, and X is stored into L. If the value of X is greater than k′ then the output of comparator2, X>k′ becomes high, and if Y input is high corresponding AND2 gate produces MW high, and X is stored into H. Two AND gates produce MW high signal using the label Y. After learning is completed the label Y is low, at the testing stage. If testing variable X′ is greater than or equal to k then the corresponding OR1 gate output becomes high at the same time if input variable X′ is less than or equal to k′ corresponding OR2 gate output becomes high and if both the OR gate outputs are high the AND3 gate produces output Y′ high. The pairs (X, Y) and (X′, Y′) are for training and testing respectively. After learning is completed, if the input variable X′ is greater than or equal to k and less than or equal to k′, the output Y′ is high and X′ is less than k or greater than k′ then the output Y′ is low. After learning is completed, the subtracter calculates k′−k and the divider calculates (k′−k)/k′, known as divergence. The subtracter and the divider are enabled only when the learning is completed.

Here comparators, memory locations, the subtractor, and the divider are digital circuits suitable for the SALS model. In an analog signal processing scenario, digital circuits are replaced by analog circuits, and the memory locations L and H can also be replaceable with analog memories.

The SALS device manipulates a single continuous variable x with a binary label Y, if x is within a particular range of lower-upper limit values, Y is high and if x is outside the range Y is low as shown below:

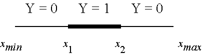

When the value of x is between xₘᵢₙ and x₁ label Y=0, when x is between x₁ and x₂, Y=1, and when x is between x₂ and xₘₐₓ, Y=0, then x₁ is the lower limit and x₂ is the upper limit. The lower and upper limits of x is learned using a learning model, wherein if (x, Y) data set are available and the device can produce the Label Y when x values are only available. After the training steps, if the values of lower limit and upper limit remains unchanged, then it is said to be converged. The lower limit is represented as k and the upper limit is represented as k′. After convergence the value of k′−k remains stable. Then the device evaluates (k′−k)/k′. The learning model is shown below.

1. Initialize k = xₘₐₓ and k′= x ₘᵢₙ
2. r^{th} training step: check whether Yᵣ = 0 or 1

If Yᵣ = 1 and k > xᵣ store xᵣ in the location L
If Yᵣ= 1 and k′< xᵣ store xᵣ in the location H

3. Go to step 2 until the learning process is completed
4. Evaluate (k′ − k)/k′

End

In this model the contents of the memory locations L and H are k and k′ respectively. In the step 2, if Y=1, the value xᵣ is compared with the values k and k′. If Y=1 and xᵣ is less than k, then k is replaced with the value of xᵣ. If Y=1 and xᵣ is greater than k′, then k′ is replaced with the value of xᵣ. This process is repeated until the end of training pairs (x, Y). This model is the SALS model, and the learning device is named the SALS device. If Y=1 for m number of x values, then k and k′ are represented as shown in the equation (1) and (2) respectively.

$$k = {min}_{r ϵ [ 1 , … , m ]} {\sum }_{r = 1}^{m} {x}_{r} for all {Y}_{r} = 1 \qquad equation ( 1 )$$

$${k}^{′} = {max}_{r ϵ [ 1 , … , m ]} {\sum }_{r = 1}^{m} {x}_{r} for all {Y}_{r} = 1 \qquad equation ( 2 )$$

Where k is the lower limit, k′ is the upper limit, m is the number of training samples, xᵣ is the r^{th} value of variable x, Yᵣ is the r^{th} value of variable Y, and min indicates the least and max indicates the highest.

For example, the relevance of k and k′ in machine learning can be understood easily. When the K number of SALS devices learn the K number of classes, having the same feature variable x, then there is a K number of the lower limit and upper limit values. If the k′−k values are very low for each class, the feature variable x becomes more distinguishable, or the classes are distinguishable from one class to another using the single feature variable x. For K number of classes, if their feature variable's ranges are mutually exclusive as shown below, then the classes are easily separable using the single variable x.

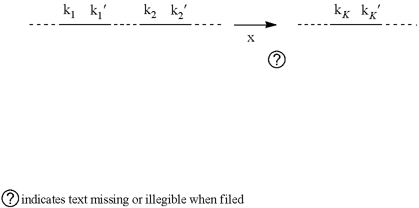

By considering k₁, k₂, . . . , k_{K} as lower limits and k₁′, k₂′, . . . , k_{K}′ as the upper limits for a particular feature variable x, and k₁, k₂, . . . , k_{K} and k₁′, k₂′, . . . , k_{K}′ are having different values and ranges then k₁ and k₁′, k₂ and k₂′, . . . , k_{K} and k_{K}′, are mutually exclusive, the single feature variable is enough to distinguish the classes. Normally the ranges overlap with each other hence, a number of feature variables are used to distinguish the K number of classes one from another, if the number of feature variables increases, the probability of class interference decreases. In other words, the classification boundaries become separable and classification accuracy approaches to 100% By combining different feature variables. When the feature variables are combined the number of feature relations is expanded, also, the relations among these variables are measured.

After convergence k′−k is proportional to the divergence, when k′−k value is low; it makes less interference among classes. The divergence div is measured as

$$d i v = ( {k}^{′} - k ) / {k}^{′} \qquad equation ( 3 )$$

Where div is the divergence, k′ and k are the upper limit and the lower limit values of x after convergence. The div is a significant term when the div increases the probability of class interference increases. When div reduces the probability of class interference reduces. From equation (3).

$$d i v = 1 - k / {k}^{′} \qquad equation ( 4 )$$

The convergence is inversely proportional to div, and the convergence occurs when div<1. In the simplified Python code, it is represented as given below.

if div < threshold:
Converged # threshold is very much less than 1

It describes how a SALS device can learn a single variable. When multiple variables are considered, each variable may have a relation with another variable, but the relations are unknown to the model. In convention ANN, these relations are considered as weights among variables. So, each variable is multiplied with a weight value, and they are summed in a neuron.

In the proposed method, two variables are combined into a single variable by addition or multiplication with a single weight. If Xₚ and X_{q} are two variables, then output O_{p,q} is simply represented as follows.

$${O}_{p , q} = {X}_{p} + {w}_{p , q} \cdot {X}_{q} \qquad equation ( 5 )$$

Equation (5) is the Two Variable Addition method (TVA)

$${O}_{p , q} = {X}_{p} \cdot {w}_{p , q} \cdot {X}_{q} \qquad equation ( 6 )$$

Equation (6) the Two Variable Multiplication method (TVM)

Where O_{p,q} is the output of variable numbers p and q, Xₚ is the p^{th} variable, w_{p,q} is the weight for variable numbers p and q, and X_{q} is the q^{th} variable. By using TVA or TVM two variables became a single variable, now equations (1) and (2) are written as shown below using TVA.

$${k}_{p , q} = {min}_{r ϵ [ 1 , … , m ]} ( {\sum }_{r = 1}^{m} {x}_{p , r} + {w}_{p , q} \cdot {x}_{q , r} ) \qquad equation ( 7 )$$

$${k}_{p , q}^{′} = {max}_{r ϵ [ 1 , … , m ]} ( {\sum }_{r = 1}^{m} {x}_{p , r} + {w}_{p , q} \cdot {x}_{q , r} ) \qquad equation ( 8 )$$

Or equation (1) and (2) are written as shown below using TVM

$${k}_{p , q} = {min}_{r ϵ [ 1 , … , m ]} ( {\sum }_{r = 1}^{m} {x}_{p , r} \cdot {w}_{p , q} \cdot {x}_{q , r} ) \qquad equation ( 9 )$$

$${k}_{p , q}^{′} = {max}_{r ϵ [ 1 , … , m ]} ( {\sum }_{r = 1}^{m} {x}_{p , r} \cdot {w}_{p , q} \cdot {x}_{q , r} ) \qquad equation ( 10 )$$

Where k_{p,q} is the minimum value among TVA or TVM relations, m is the number of training elements in the training set and k′_{p,q} is the maximum value among TVA or TVM relations. Now, from equations of k and k′ (equations (7), and (8)) divergence div is written as shown below.

$$d i v = 1 - {k}_{p , q} / {k}_{p , q}^{′} \qquad equation ( 11 )$$

### AIW Method:

When only one weight is there, connecting the two variables, the weight w is found by the Approximation by Iterations of Weights (AIW) method. This method uses the changing values of div for different weights.

In this method, initially, the input variables Xₚ, X_{q}, and a threshold value are accessed. Then it selects a minimum weight value and evaluates the div value using equations (7), (8), and (11), represented as div1. Then another maximum weight is selected and evaluates the div value and represented as div2. The present weight is represented as weight1, the previous weight is represented as weight2, the present div is represented as div1, and the previous div is represented as div2. The weight value converges according to the method and when the weight converges the value of the present div is minimum, it is stored as div3, and the corresponding optimized weight is stored as weight3. After the iterations, if div3 is less than a threshold value the method returns the optimum weight. The learning rate is exponentially decaying as shown in the method.

By considering X₁, X₂, X₃, . . . , Xₙ as n number of variables, the first variable is combined with the second, third, . . . , and the n^{th} variables. The second variable is combined with the third, fourth, . . . , and n^{th} variables. These processes are done for all variables in the layer. Then, the total number of combined variables is

$${N}_{l} = n ( n - 1 ) / 2 \qquad equation ( 12 )$$

Where N₁ is the number of variables in layer l and n is the number of output variables in the layer l−1.

In the preferred embodiment of the present invention, wherein in Divergence for Feature Filtering (DFF) method of n variables, N₁ number of two variable combinations as shown in equation (12) are examined whether div value is less than the threshold value provided to the AIW method. If the div value is less than the threshold value, that AIW method output and corresponding weight are considered valid, otherwise they are invalid. The simplified Python code for DFF method is provided in the following nested loops.

```
for p in range (n):
  for q in range (p + 1, n):
    AIW ( ) # perform AIW method using values of p and q
```

Where n is the number of variables in the layer l. Among the outputs of the DFF method, the valid outputs depend upon the threshold value provided to the model and it is adjusted in order to get m₁ number of outputs and corresponding two variable combinations, where m₁≤n, n is the number of variables provided as input to the DFF method, and which is equal to the number of valid outputs of the previous layer. The condition m₁≤n should be satisfied for further processing using the same computational resources of N₁ number Processing Elements (PE) in equation (12), and each PE performs the function of the AIW method.

In order to obtain maximum inter-variable relations and features, the output of layer l is further processed using the DFF method with corresponding thresholds, as shown simplified Python code below.

Threshold_array = [0, th1, th2, ...thL]
for l in range (1, L+ 1): #From layer 1 to layer L

Threshold= Threshold_array[l]
DFF ( )# Perform DFF method using threshold value in each layer.

Where th1, th2, . . . , thL are threshold values of layer2, layer3, . . . , layer L, and Lis the maximum number of layers. Each layer performs the DFF method and filters m₁ number of outputs depending on the corresponding threshold values.

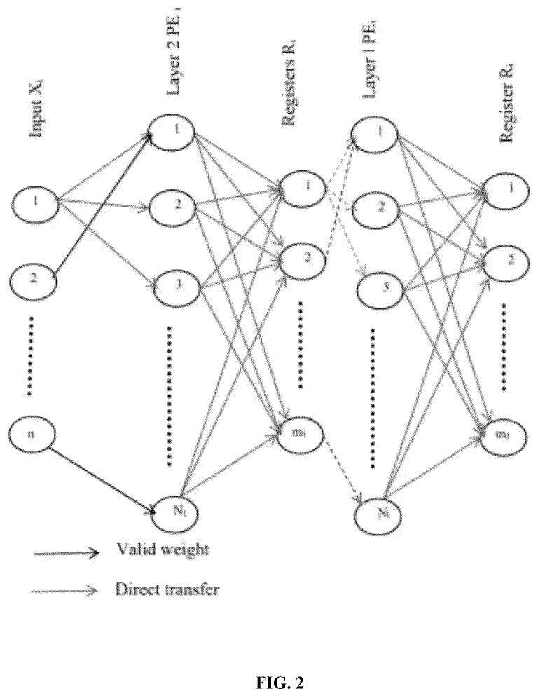

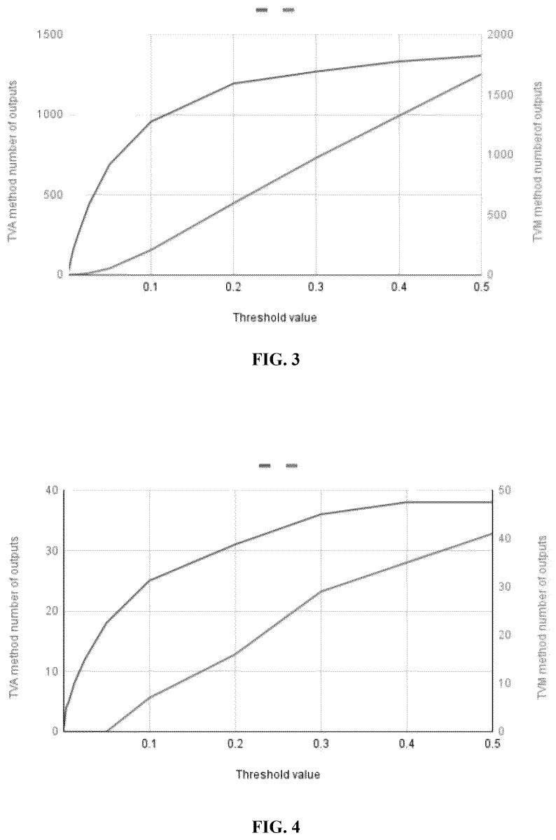

FIG. 2 shows a pictorial representation of the model. The first layer is the input layer, and the remaining layers perform the DFF method. The number of outputs in each layer is limited to m1 as described above. The threshold values are processed in the network as shown in the AIW method. It is observable that each layer is followed by an array of m1 number of registers, where the outputs are divided by the average value of k′ defined in the AIW method. These m1 number of outputs are applied to the input of the next layer. The input data for a particular layer l is the output data of layer l−1. Hence the layer structure is repeated. In FIG. 2 blue lines indicate the transfer of the same value from one location to another location as indicated in the arrow mark. The dark lines indicate a multiplication of a value in a location with a valid weight. Each PE performs an AIW method using two input variables and searches for a valid weight for TVA or TVM relation. Hence the number of weight values between adjacent layers is low.

In the Least Divergence Feature in a Block (LDFB) method n−1 number of two variable combinations are examined as shown in the Python code below. In the code, if the div value of the AIW method is less than the threshold value, the inner while loop is broken and the corresponding AIW output and weight are considered as valid, otherwise not valid. The LDFB method is performed as shown in the nested loop of the simplified Python code shown below.

```
Threshold = th1
for p in range (n):
    q = p+ 1
  while q < n:
        div = AIW ( ) # Perform AIW
        method values of p and q are used
      q =q+ 1
        if div < Threshold:
          q = n
```

Where th1 is a predetermined threshold value, n is the maximum number of variables, and div is the divergence returned by the AIW method, and it uses values of p and q as mentioned in equations (7), (8), and (11). The maximum number of outputs obtained is n−1 and the LDFB method is faster than the DFF method for some image classification applications.

In order to combine the extracted outputs of the DFF or LDFB layer a Reverse Tree Method of Combination (RTMC) is used. In this method, there are b—a number of steps, and at each step, the number of outputs is reduced to less than half of the previous step. RTMC method combines two input variables when the div value of the AIW method is less than the threshold value. It is designed for obtaining the number of variables at the b^{th} step which is less than or equal to one. The simplified Python code is given below.

```
Threshold = th1
Count1=n
for l in range (a ,b+ 1): # Start from a to b
Count2=count1
Count1= −1
  for p in range (0, Count2, 2):
      q=p+ 1
    div = AIW ( ) #Perform AIW method using value of p and q
      if div < Threshold:
        Count1= Count1+ 1
```

Where th1 is the threshold value, n is the number of variables obtained from the previous layer, a is the previous layer number, b is the maximum number of steps, div is the divergence obtained from the AIW method, and it uses values of p and q as mentioned in the equations (7), (8), and (11).

### Test Results

In order to calculate the number of valid outputs of the AIW model using the DFF method, a few segmented images of the same objects from the Washington RGB object data set are selected and converted to 16×16 gray-level images. Each pixel position is considered as a variable and the DFF method is executed. FIG. 6 shows the resultant graphical representation of the experiments. The vertical axis shows the number of valid AIW outputs using the TVA method. The right vertical axis shows the number of valid outputs from the AIW model of the TVM method, and the horizontal axis shows the threshold values applied to the AIW method.

In order to calculate the number of valid outputs of the AIW model using the LDFB method, Washington RGB images and threshold values of the previous experiment with the same condition are used. Then the LDFB method is executed.

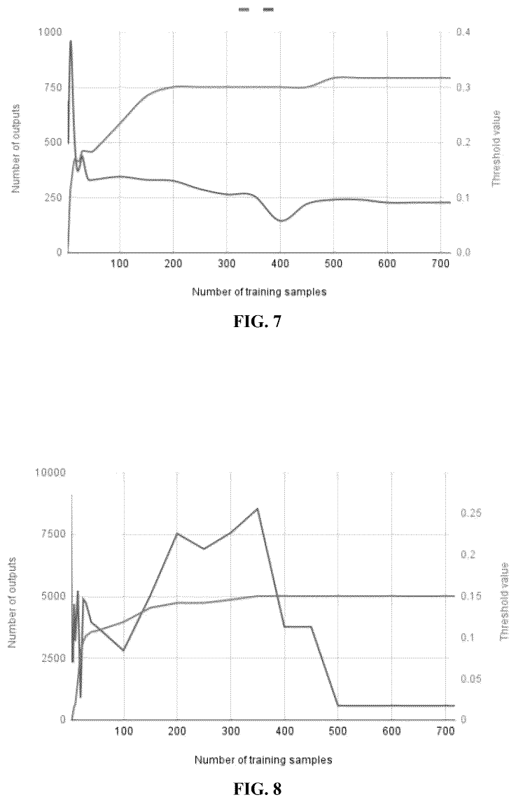

FIG. 7 illustrates the resultant graph in which the horizontal axis represents the threshold values, the vertical axis represents the number of valid outputs of the AIW model using the TVA method, and the right vertical axis shows a number of valid outputs of the AIW model using the TVM method. It is observable that a large number of valid outputs of the AIW method are obtained with minimum threshold values at the TVA method and the threshold value can be used to control the number of outputs in a layer.

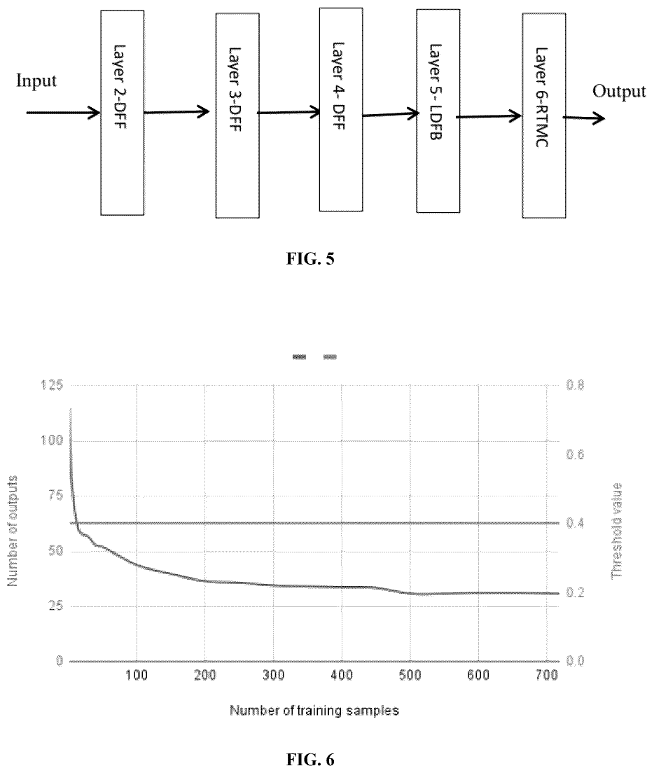

In another embodiment of the present invention, wherein a Pen-Based Recognition of Handwritten Digits data set encompasses handwritten digit samples contributed by 44 diverse writers, presenting both original and normalized versions for comprehensive analysis. Notably, it maintains class balance across the numerical spectrum from 0 to 9, ensuring equitable representation for model training and evaluation. Capturing nuances in writing speed through variable-length inputs, the dataset offers researchers a rich and varied resource to develop and assess robust handwritten digit recognition models. In order to train to classify this data set, the architecture shown in FIG. 5 is used. Input is given in the first layer. Layers 2 to 4 extract more variable combinations, when div values are less than the corresponding threshold values, using the DFF method. The fifth layer uses the LDFB method to limit the number of variables. Layer 6 combines the outputs of layer 5 using the RTMC method. Each layer performs based on the AIW method. In order to find the lower limit and upper limit values of the final output, layer 6 is applied to a SALS model.

FIG. 5 illustrates the model classification network in which input is applied in layer 1, layers 2 to 4 extract inter-variable relations, layer 5 limits the number of outputs, and layer 6 combines the outputs of layer 5 to a single output O layer. The training set is applied as an input at layer 1. At the remaining layers, when the AIW method provides a valid output, the corresponding node produces a memory identity named as output number. Then the output number, weight, k′ values, and the identities of combined two variables from the previous layer are stored in a memory location corresponding to the layer number. In order to normalize the valid outputs of the AIW method, which are divided by the average k′ value of a layer for applying as input to the next layer. The lower limit and upper limit values of output at the ending layer are also stored in the memory location.

At the testing stage, a test instance is applied in the first layer. The remaining layers contain the trained data such as a number of valid relations, weights, k′ values, and the output numbers of two variables from the previous layer. These two variables are processed by the TVA method same as the training stage. The processed outputs are divided by the average k′ value of the corresponding layer. These processes are repeated in the remaining layers. Finally, the end layer computes the final output. The final output is compared with the learned output using SALS Model and its output indicates whether the test instance belongs to a particular class. For simplicity, further details are excluded.

In FIG. 8, the horizontal axis shows the number of training samples, the left vertical axis shows the number of valid outputs at layer 2 using the DFF method, and the right vertical axis shows the threshold values applied for each number of training samples. It is observable that the threshold value is constant for all number of training samples.

In FIG. 9, the horizontal axis shows the number of training samples, the left vertical axis shows the number of valid outputs at layer 3 using the DFF method, and the right vertical axis shows the threshold values applied for each number of training samples.

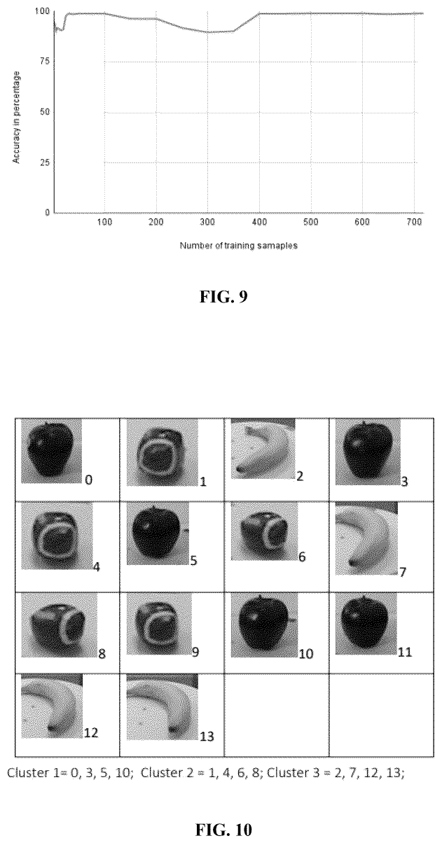

In FIG. 10, the horizontal axis shows the number of training samples, the left vertical axis shows the number of valid outputs at layer 4 using the DFF method, and the right vertical axis shows the threshold values applied for each number of training samples.

In FIG. 11, the horizontal axis shows the number of training samples, vertical axis shows the average prediction accuracy of the Pen-Based Recognition of Handwritten Digits data set.

The training is performed with different numbers of samples ranging from 2 to 719 and the testing accuracy is evaluated. The testing accuracy for the two training samples is 94.96% and for the entire 719 samples is 98.66%. It is clear that when the number of samples is very low the proposed method could extract almost all the relevant TVA relations among the input variables with low values of threshold as shown in FIGS. 9 and 10. When the number of training samples increases it is difficult to converge with low values of threshold, hence the threshold values are increased for increasing the number of valid outputs in the DFF layers as shown in FIGS. 9 and 10.

The main advantage of the proposed method is that from a single epoch, the network converges. The entire variables are processed from a single epoch and the system learns to compute the output from a few numbers of training samples as observable from the graph in FIG. 11.

FIG. 12 shows some random images of three objects from Washington RGB object datasets and each image is initially labeled from 0 to N−1. The images are converted to 16×16 gray-level images. By considering each pixel position as a variable the DFF method is applied for clustering the images. The simplified Python code is shown below.

```
Threshold=th1
Array1=np.zeros(N*2)
for n1 in range (N):
  for n2 in range (n1+ 1, N):
    DFF # Perform DFF method for input images n1 and n2
    if (number_of_valid_outputs > Threshold):
        array1[Count: Count+ 1] = n1, n2
      Count= Count+ 2
```

Where N is the number of images to be clustered as pairs, DFF method is performed for n1^{th} and n2^{th} input images as shown in the code. If the number of valid outputs of AIW model in the DFF method is greater than the threshold then the image pair is stored in the array. For image quadruple clustering the clustered image pairs are again clustered using the simplified Python code shown below.

```
Threshold=th2
Count =0
Array2=np.zeros(N*4)
for n1 in range (0, M ,2):
  for n2 in range (n1+ 2, M, 2):
    DFF( ) # Perform DFF method for input images n1, n1+ 1, n2, and
        #  n2+ 1 in the Array 1
      if (number_of_valid_outputs > Threshold):
      Array2[Count: Count+4] = n1, n1+ 1, n2, n2+ 1
      Count= Count+ 4
```

Where M is the number of image pairs in array1 to be clustered as quadruple. DFF method is performed for image labels n1, n1+1, n2, n2+1. If the number of valid outputs of the AIW in the DFF method is greater than the threshold then image quadruple is stored in array2.

The DFF method extracts a certain number of valid AIW outputs for each image pair. When two images are identical the model produces the maximum number of valid outputs. A threshold value is assigned for finding the same pair of images, if the valid outputs AIW method is greater than the threshold value, then the two images are identical. Thus, six identical pairs are obtained. Then image pair combinations are again paired to obtain quadruple similar object images. When the combined quadruple images have similar objects, the maximum valid outputs of the AIW method are obtained and filtered from the combinations of the images using another threshold value. The resultant image combinations and input image order are shown in FIG. 12.

The reason why the machine knowledge (k & k′) is in a range is that almost all the variables are affected by some errors or noises, so getting the exact values is difficult. If a particular color region in an image of an object is considered, RGB values vary from pixel to pixel, so the ranges of these RGB values can be learned.

### APPLICATIONS OF THE PRESENT INVENTION

In healthcare, it aids in accurate diagnosis by analyzing patient data, medical images, and symptoms captured through voice recordings.

In agriculture, it optimizes farming practices by processing sensor data, images of crops, and voice commands from farmers.

Autonomous vehicles benefit from its ability to interpret sensor data, images, videos, and voice instructions to navigate safely.

Enhanced security surveillance systems use it to detect intrusions, recognize faces, and alert authorities using data from sensors, cameras, videos, and voice alerts.

E-commerce platforms leverage it to personalize recommendations based on customer behavior, images, videos, and voice interactions.

Remote health monitoring, education, customer service automation, environmental monitoring, and entertainment also see significant advancements through this network, enabling personalized experiences and efficient data processing across various applications.

Discovering relationships among variables is essential across diverse fields, from predictive modeling and scientific research to business intelligence and healthcare analytics. By uncovering correlations between input variables and target outcomes, organizations can build accurate predictive models, understand complex phenomena, and inform strategic decision-making. This process aids in risk management by identifying and mitigating potential risks, while also optimizing supply chain operations and improving healthcare outcomes. Market research benefits from insights into consumer behavior and preferences, enabling targeted marketing strategies and product development. Additionally, understanding relationships among socio-economic factors informs social science research and policy-making, while climate scientists rely on such analysis to model climate patterns and predict weather events. Overall, discovering relationships among variables drives innovation, efficiency, and informed decision-making across numerous disciplines.

Data clustering finds diverse applications across fields such as marketing, computer vision, anomaly detection, recommendation systems, bioinformatics, natural language processing, spatial data analysis, economics, and network analysis. It facilitates customer segmentation in marketing, image segmentation in computer vision, and anomaly detection in various domains. Additionally, clustering aids recommendation systems by grouping users or items with similar preferences, while in bioinformatics, it assists in genomic analysis by identifying gene expression patterns. Moreover, clustering techniques are utilized in document clustering for tasks like topic modeling and information retrieval, as well as in spatial data analysis for identifying spatial patterns.

In economics, clustering helps in market segmentation, while in social network analysis, it uncovers community structures within networks. Overall, data clustering serves as a versatile tool for understanding patterns, grouping similar entities, and extracting meaningful insights from complex datasets.

It will be apparent to a person skilled in the art that the above description is for illustrative purposes only and should not be considered as limiting. Various modifications, additions, alterations, and improvements without deviating from the scope of the invention may be made by a person skilled in the art.

I claim:

1. A Supervised and Unsupervised Learning method by Fast Converging Network in an AI chip using parallel processing elements, comprising of:
a network consisting of a plurality of processing elements (PE), wherein the network is a combination of layers, and each layer comprises of unidirectional PE arrays;
a SALS (Self Learning) device that manipulates a single variable at a time, wherein the SALS device in the PE evaluates the divergence of two variable combinations, and facilitates the PE to find the convergence of weight between two variables,
wherein the combinations of different layers of the network comprises of:
i. Divergence for the Feature Filtering layer (DFF) within the network is used to find a number of relations among the variables by combining them as pairs;
ii. Least Divergence Feature in a Block layer (LDFB) is another layer within the network used to find a number of relations among the variables by pairing them together, wherein the number of relations is always less than the number of input variables applied; and
iii. Reverse Tree Method of Combination layer (RTMC) layer in the network is used to combine the input variables using multiple iterative 20 steps and with each step, the number of variables is reduced to less than or equal to half of the input variable, wherein these steps continue until the variable number becomes one,
wherein an approximation by iteration of weight method in the PE uses the SALS device to converge fast and to determine the relation between two variables to combine the feature variables into a single variable, and
wherein PE is a sub-processor within the network.

2. The supervised and unsupervised learning method as claimed in claim 1, wherein network converges after a single epoch.

3. (canceled)

4. (canceled)

5. (canceled)

6. The supervised and unsupervised learning method as claimed in claim 1, wherein for the supervised learning, a label is required for each variable, and the label represents the nature of the variable, whether it is in a particular class or not.

7. The supervised and unsupervised learning method as claimed in claim 1, wherein the network performs unsupervised learning using the convergence property of SALS device without a label, wherein the network is designed to learn patterns and relationships in the input data based on the features or characteristics of data.

8. The supervised and unsupervised learning method as claimed in claim 1, wherein the Classification of the data refers to the process of organizing or categorizing data based on its distinct attributes, wherein the classification process allows the device to categorize the input data accurately, enabling various applications such as image recognition, text analysis, and speech recognition.

9. The supervised and unsupervised learning method as claimed in claim 1, wherein the SALS device processes each variable individually and the approximation by iteration of weight method uses the SALS device for pairwise combinations.

10. (canceled)

11. The supervised and unsupervised learning method as claimed in claim 1, wherein when multiple variables are considered, each variable has a relation with another variable and these relations are regarded as weights among variables.

12. The supervised and unsupervised learning method as claimed in claim 1, wherein the two variables are combined into a single variable by addition or multiplication with one of the variables multiplied by a single weight.

13. The supervised and unsupervised learning method, as claimed in claim 1, wherein the SALS device provides a learning method comprising of
i. if the input variable is within a range, between a lower limit value and an upper limit value, then its label is high;
ii. the input variable values are learnable using a learning model when the label is high;
iii. the device produces the label high with the same input variable in the range and the device produces the label low with the same input variable outside the range after learning;
iv. the tested input-output pairs satisfy the input-label relations in the learning pairs;
V. the value of divergence=(upper limit−lower limit)/upper limit is measurable; and
vi. the device is used for supervised learning, and unsupervised learning, wherein the SALS device can produce an output high after learning is complete if the input variable is in a particular range.

14. The supervised and unsupervised learning method as claimed in claim 1, wherein the label is high (1) for input variable values within a range and low (0) for input variable values outside the range.

15. (canceled)

16. The supervised and unsupervised learning method as claimed in claim 1, wherein when only one weight is provided connecting two variables, and the weight w is found by Approximation by Iterations of Weights (AIW) method which uses the changing values of divergence (div) for different weights, wherein for optimal convergence of network, divergence should be less than a minimum value which is a threshold value of a data set.

17. The supervised and unsupervised learning method as claimed in claim 16, wherein the AIW method compares different weights, and optimal weight is determined when the value with the minimum div is less than a threshold value obtained after iterations.

18. The supervised and unsupervised learning method as claimed in claim 1, wherein the SALS device consists of two N-bit comparators, two N-bit memory locations, an N-bit subtractor, an N-bit divider, three AND gates, and two OR gates.
